(19) United States
(12) Patent Application Publication
(10) Pub. No.: US 2025/0165327 A1
(43) Pub. Date: May 22, 2025

(54) ASSEMBLY METHOD AND APPARATUS, ELECTRONIC DEVICE, AND STORAGE MEDIUM

(71) Applicants: Cosmo Institute of Industrial Intelligence (Qingdao) Co., LTD., Qingdao (CN); Haier Cosmo IOT Technology Co., Ltd., Qingdao (CN)

(72) Inventors: Lucheng CHEN, Qingdao (CN); Liyang Dong, Qingdao (CN); Chenggang Qin, Qingdao (CN); Xiangxiu Meng, Qingdao (CN); Shuo Zhang, Qingdao (CN); Shuxiao Cui, Qingdao (CN)

(21) Appl. No.: 18/957,580

(22) Filed: Nov. 22, 2024

(30) Foreign Application Priority Data
Nov. 22, 2023 (CN) 202311559206.3

(51) Int. Cl. G06F 11/07; G06F 9/30

(52) U.S. Cl. CPC G06F 11/0769; G06F 9/3016; G06F 11/0721

(57) ABSTRACT

An assembly method includes acquiring process text, inputting the process text into a unimodal model, and generating machine instructions, where the machine instructions are represented in computer language; controlling an assembly device to execute the machine instructions; in response to receiving a first error message sent by the assembly device, determining the remaining text based on the first error message, using the remaining text as new process text, and returning to the step of inputting the process text into the unimodal model and generating the machine instructions; and in response to receiving no first error message sent by the assembly device, completing assembly.

### CROSS-REFERENCE TO RELATED APPLICATION(S)

This application claims priority to Chinese Patent Application No. 202311559206.3 filed Nov. 22, 2023, the disclosure of which is incorporated herein by reference in its entirety.

### TECHNICAL FIELD

The present disclosure relates to the field of Industrial-Internet-based intelligent manufacturing technologies, particularly an assembly method and apparatus, an electronic device, and a storage medium.

### BACKGROUND

With the rise of the Fourth Industrial Revolution and the deep integration of the digital world and the physical world, the development of flexible assembly systems that can optimize and adapt in real time is a key trend for the future of smart factories. Flexible assembly systems are characterized by automation, mobility, and digitalization, enabling them to effectively reduce the production costs and improve the assembly efficiency.

Currently, most flexible assembly systems are based on expert systems designed for specific rules, which can only use predefined expert knowledge for reasoning. This undoubtedly limits the flexibility of the assembly line and prevents it from quickly adapting to the personalized demands of today's product customization era, where production orders are diverse, and batch sizes are small. Additionally, in existing flexible assembly systems, when anomalies occur during the assembly process, manual intervention is often required, significantly reducing the assembly efficiency.

### SUMMARY

The present disclosure provides an assembly method and apparatus, an electronic device, and a storage medium. This solution can enhance the flexibility of the assembly system while monitoring the execution process of the machine instructions, ensuring that machine instructions are regenerated in the event of an error, thereby improving the smoothness and efficiency of the assembly process.

According to an aspect of the present disclosure, an assembly method is provided. The assembly method includes acquiring process text, inputting the process text into a unimodal model, and generating machine instructions, where the machine instructions are represented in computer language; controlling an assembly device to execute the machine instructions; in response to receiving a first error message sent by the assembly device, determining the remaining text based on the first error message, using the remaining text as new process text, and returning to the step of inputting the process text into the unimodal model and generating the machine instructions, where the first error message is acquired based on an exception capturing module of the assembly device, the exception capturing module has a fixed pattern, and the remaining text includes at least part of the process text; and in response to receiving no first error message sent by the assembly device, completing assembly.

Optionally, acquiring the process text includes acquiring assembly information, inputting the assembly information into a multimodal model, and determining a process step, where the assembly information includes assembly text and an assembly drawing, and the process step is represented in natural language; and determining the process text based on the process step and a process knowledge graph associated with the assembly drawing.

Optionally, determining the remaining text includes determining executed instructions, where the executed instructions are instructions that are among the machine instructions and that have been executed when the assembly device sends the first error message; determining executed text based on the executed instructions; and determining the remaining text based on the executed text and the process text.

Optionally, after determining the process step, the method also includes determining the matching degree between the process step and a standard step corresponding to the assembly drawing; in response to determining that the matching degree between the process step and the standard step corresponding to the assembly drawing is less than a preset threshold, generating a second error message; and updating the assembly information based on the second error message and returning to the step of inputting the assembly information into the multimodal model and determining the process step until the matching degree between the process step and the standard step corresponding to the assembly drawing is greater than or equal to the preset threshold.

Optionally, determining the process text based on the process step and the process knowledge graph associated with the assembly drawing includes decomposing the process step to obtain several process actions and an action topology, where the action topology is configured to indicate the position and the dependency relationship of each of the process actions in the process step; determining action text corresponding to each of the process actions based on the process knowledge graph; and combining action text corresponding to the process actions according to the action topology to obtain the process text.

Optionally, the process step includes process requirements, and the process knowledge graph includes a basic graph and an encapsulation function; and for any of the process actions, determining action text corresponding to the process action based on the process knowledge graph includes determining a workpiece feature and an assembly feature of the process action based on the basic graph; determining a control parameter of the process action based on the encapsulation function, with the process requirements as constraints; and determining the action text corresponding to the process action based on the workpiece feature, the assembly feature, and the control parameter.

Optionally, an input end of the unimodal model is provided with a primitive function library, the primitive function library includes an instruction function, the instruction function is represented in the computer language, and the computer language includes at least one of machine language, assembly language, high-level language, or specialized language; and inputting the process text into the unimodal model and generating the machine instructions includes constructing a model prompt based on the process text and the primitive function library; and inputting the model prompt into the unimodal model and generating the machine instructions.

Optionally, after completing the assembly, the assembly method also includes acquiring an assembly result; in response to determining that the assembly result does not match a preset result corresponding to an assembly drawing, generating a third error message; and updating the model prompt based on the third error message and returning to the step of inputting the process text into the unimodal model and generating the machine instructions until the assembly result matches the preset result corresponding to the assembly drawing.

According to another aspect of the present disclosure, an assembly apparatus is provided. The assembly apparatus includes a text determination module, an instruction generation module, and a control module. The text determination module is configured to acquire process text. The instruction generation module is configured to input the process text into a unimodal model and generate machine instructions, where the machine instructions are represented in computer language. The control module is configured to control an assembly device to execute the machine instructions and, in response to receiving no first error message sent by the assembly device, complete assembly. The text determination module is also configured to, in response to receiving a first error message sent by the assembly device, determine remaining text based on the first error message, where the first error message is acquired based on an exception capturing module of the assembly device, and the exception capturing module has a fixed pattern. The instruction generation module is also configured to use the remaining text as new process text and return to the step of inputting the process text into the unimodal model and generating the machine instructions, where the remaining text includes at least part of the process text.

According to another aspect of the present disclosure, an electronic device is provided. The electronic device includes at least one processor and a memory communicatively connected to the at least one processor. The memory stores a computer program executable by the at least one processor to enable the at least one processor to perform the assembly method of any embodiment of the present disclosure.

According to another aspect of the present disclosure, a computer-readable storage medium is provided. The computer-readable storage medium stores computer instructions. The computer instructions are configured to enable a processor to perform the assembly method of any embodiment of the present disclosure when the computer instructions are executed by the processor.

Solutions of embodiments of the present disclosure involve inputting the acquired process text into a unimodal model, and generating machine instructions; controlling an assembly device to execute the machine instructions; in response to receiving a first error message sent by the assembly device, determining the remaining text based on the first error message, using the remaining text as new process text, and returning to the step of inputting the process text into the unimodal model and generating the machine instructions; and in response to receiving no first error message sent by the assembly device, completing assembly. The introduction of a unimodal model in the process of converting process text into machine instructions represented in computer language solves the problem in the related art where reasoning is limited to established expert knowledge, thereby enhancing the flexibility of the assembly system. Moreover, the execution process of the machine instructions is monitored by the exception capturing module of the assembly device. When the first error message sent by the assembly device is received, the remaining text is determined and used as new process text to regenerate machine instructions, eliminating the need for manual intervention, freeing up human resources, and improving the smoothness and efficiency of the assembly process.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

Drawings used in description of embodiments of the present disclosure are described hereinafter. Apparently, these drawings illustrate part of embodiments of the present disclosure. Those of ordinary skill in the art may obtain other drawings based on these drawings on the premise that no creative work is done.

FIG. 1 is a flowchart of an assembly method according to an embodiment of the present disclosure.

FIG. 2 is a diagram of the architecture of a large language model according to an embodiment of the present disclosure.

FIG. 3 is a flowchart of an assembly method according to an embodiment of the present disclosure.

FIG. 4 is a diagram illustrating the structure of a display apparatus according to an embodiment of the present disclosure.

FIG. 5 is a diagram illustrating the structure of an electronic device according to an embodiment of the present disclosure.

### DETAILED DESCRIPTION

For a better understanding of solutions of the present disclosure by those skilled in the art, solutions in embodiments of the present disclosure are described clearly and completely hereinafter in conjunction with the drawings in embodiments of the present disclosure. Apparently, the embodiments described hereinafter are part, not all, of embodiments of the present disclosure. Based on embodiments of the present disclosure, all other embodiments obtained by those of ordinary skill in the art on the premise that no creative work is done are within the scope of the present disclosure.

It is to be noted that the terms such as “first”, “second” and “third” in the description, claims and above drawings of the present disclosure are used to distinguish between similar objects and are not necessarily used to describe a particular order or sequence. It is to be understood that the data used in this way is interchangeable where appropriate so that embodiments of the present disclosure described herein may also be implemented in a sequence not illustrated or described herein. Additionally, terms “include” and “have” and any variations thereof are intended to encompass a non-exclusive inclusion. For example, a process, method, system, product or device that includes a series of steps or units not only includes the expressly listed steps or units but may also include other steps or units that are not expressly listed or are inherent to such process, method, product or device.

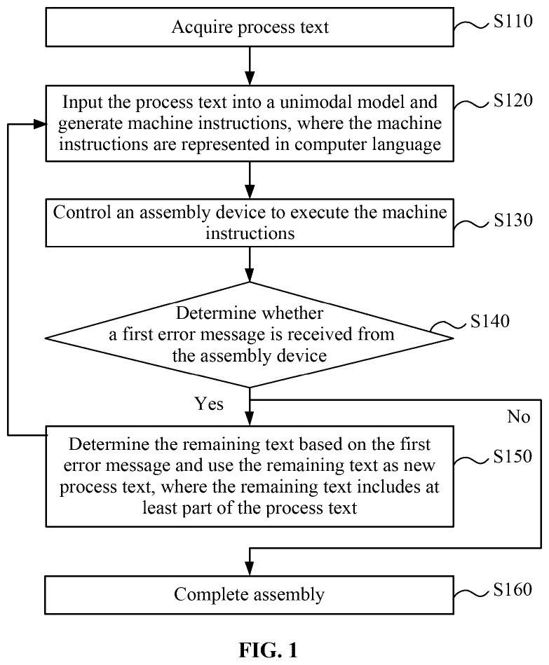

FIG. 1 is a flowchart of an assembly method according to an embodiment of the present disclosure. This embodiment is applicable to scenarios where executable machine instructions are generated for an assembly device and the execution of these instructions is monitored. The assembly device is the device used in the assembly system to perform assembly tasks. The method can be executed by an assembly apparatus. The assembly apparatus can be implemented in hardware and/or software and can be configured in an electronic device (such as a computer, processor, or server). For example, the electronic device may be integrated into an assembly system. As shown in FIG. 1, the method includes the following steps:

In S110, process text is acquired.

The assembly method of the present disclosure can be applied to various assembly systems, such as flexible assembly systems. The assembly system can have the ability to interact in real time with its environment through perception and interaction (also known as embodied intelligence) to fulfill the user's assembly requirements. Typically, an assembly requirement includes one or more assembly plans. For example, if the user's assembly requirement is to assemble a washing machine, since the washing machine includes multiple components such as a solenoid valve, motor, and clutch, each component needs to be assembled separately before being assembled together. Each component corresponds to an individual assembly plan, so the assembly requirement for the washing machine includes multiple assembly plans.

In an embodiment, step S110 may include the following two steps:

In step a1, assembly information is acquired, the assembly information is input into a multimodal model, and a process step is determined, where the assembly information includes assembly text and an assembly drawing, and the process step is represented in natural language.

The assembly information is information determined based on the assembly plan. The assembly information includes assembly text and an assembly drawing. The assembly text and the assembly drawing are typically in one-to-one correspondence. The assembly text is used to describe the assembly plan and can be either a brief description or a detailed description of the plan. The assembly drawing represents the working principles, motion methods, connections, and assembly relationships between the workpieces involved in the assembly plan.

In a possible embodiment, the assembly apparatus may be preconfigured with multiple data pairs. Each data pair includes an assembly text and an assembly drawing. The method of acquiring assembly information can involve user selection, where the user selects a data pair to serve as the assembly information.

In another possible embodiment, the assembly apparatus may be preconfigured with multiple data pairs. Each data pair includes an assembly text and an assembly drawing. The method of acquiring assembly information can involve receiving a text or voice command from the user, searching for the assembly text that has the highest similarity to the text or voice command, and using the data pair corresponding to the assembly text as the assembly information.

In another possible embodiment, the method of acquiring assembly information may include collecting the voice input from the user and converting the voice information into text information by using a speech recognition algorithm; and determining the assembly text and the assembly drawing based on the text information.

In an embodiment, to achieve fully automated parsing of assembly information, the present disclosure pretrains a multimodal model. The assembly information is input into the multimodal model, and through the model's parsing and reasoning, the process step is output, thereby achieving the automatic conversion from the assembly drawing to the process step, providing strong support for production line automation. The process step is represented in natural language.

Inputting the assembly information into the multimodal model and determining the process step may include inputting the assembly information into the multimodal model, parsing the assembly information by using the model, and determining the process step.

The multimodal model is an artificial intelligence model capable of processing multiple types of data, such as text, pictures, audio, and video, with the goal of providing more comprehensive and accurate information by combining different types of data. In the present disclosure, the multimodal model can be any large language model having an open-source interface or a callable interface.

In step a2, the process text is determined based on the process step and a process knowledge graph associated with the assembly drawing.

Due to the specialized terminology involved in assembly tasks, the process step determined in step a1 cannot be directly executed by the assembly device. Therefore, it is necessary to convert the process step, which is expressed in natural language, into machine instructions represented in computer language. In the conversion process, to address the problem that existing technologies can only perform reasoning based on established expert knowledge, the present disclosure uses a unimodal model. Since the process step cannot be directly used as input for the unimodal model, it is also necessary to convert the process step into process text (also understood as a sequence of text) that can be recognized by the unimodal model.

The process knowledge graph is a knowledge graph constructed based on experiences in the field of industrial internet smart manufacturing. Typically, one assembly plan corresponds to one process knowledge graph. Therefore, the process knowledge graph is associated with the assembly drawing of its corresponding assembly plan.

In an embodiment, determining the process text based on the process step and the process knowledge graph associated with the assembly drawing includes decomposing the process step to obtain several process actions and an action topology, where the action topology is configured to indicate the position and the dependency relationship of each of the process actions in the process step; determining action text corresponding to each of the process actions based on the process knowledge graph; and combining action text corresponding to the process actions according to the action topology to obtain the process text. The process text constructed in this manner has a fixed pattern so that when used as input to the unimodal model, the process text can constrain the model's thinking and reasoning abilities. This avoids the problem of erroneous instructions being generated due to the model's inherent tendency to produce unrealistic outputs, thus ensuring the accuracy of the machine instructions generated subsequently.

In S120, the process text is input into a unimodal model, and machine instructions are generated, where the machine instructions are represented in computer language.

The unimodal model can be a pretrained model capable of converting process text into machine instructions that can be executed by the assembly device. In the present disclosure, the unimodal model can be any large language model having an open-source interface or a callable interface.

In an embodiment, an input end of the unimodal model is provided with a primitive function library, the primitive function library includes several instruction functions, the instruction functions are represented in the computer language, and the computer language includes at least one of machine language, assembly language, high-level language, or specialized language. Thus, the primitive function library can be used to optimize the process text, ensuring that the unimodal model operates according to the established pattern, thereby guaranteeing the generation of correct machine instructions.

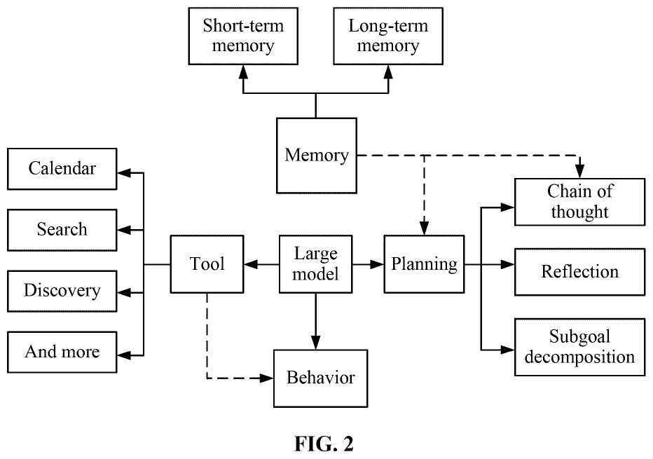

For the large language model (also referred to as the “large model”) mentioned in the present disclosure, FIG. 2 illustrates the architecture of a large language model according to an embodiment of the present disclosure. As shown in FIG. 2, the large language model is an intelligent model capable of autonomous understanding, planning, execution, and ultimately completing tasks. The large language model is equipped with three core capabilities: memory, planning, and tools, which together enable the construction of a fully autonomous intelligent agent with self-awareness and action capabilities. The memory capability includes contextual memory during a one-time task process and external data stored in a vector database, which can be accessed and retrieved at any time. The planning capability allows the large model to break down tasks into multiple subtasks, set and adjust priorities, primarily involving task decomposition and self-reflection. Commonly used techniques for task decomposition include Chain of Thought and Tree of Thought. Self-reflection enables the model to improve its task decisions continuously by utilizing feedback during task execution, even correcting previous mistakes to iterate and improve over time. The use of external tools significantly extends the functionality of the large language model. For instance, it can invoke other specialized artificial intelligence (AI) models for specific tasks, call APIs for applications like weather queries, and retrieve enterprise information.

In S130, an assembly device is controlled to execute the machine instructions.

In S140, it is determined whether a first error message is received from the assembly device; if yes, step S150 is performed; and if no, step S160 is performed.

Since the assembly device may take some time to execute the machine instructions, it needs to continuously monitor during this period to determine whether the first error message has been received from the assembly device. When the first error message is received, it is indicated that an error has occurred in the machine instructions, at which point step S150 is executed to regenerate the machine instructions. If the first error message is not received, it is indicated that the machine instructions have been executed correctly, and step S160 is executed to complete the assembly task.

In an embodiment, the assembly device may be configured with an anomaly detection module, and the first error message is obtained based on the anomaly detection module of the assembly device. The anomaly detection module has a fixed pattern to ensure that the assembly device can regenerate the correct machine instructions even in the event of an assembly anomaly.

In S150, the remaining text is determined based on the first error message, the remaining text is used as new process text, and S120 is performed again, where the remaining text includes at least part of the process text.

In an embodiment, the first error message can be understood as an external stimulus to the model, thereby enabling the update of the machine instructions based on the external stimulus.

The remaining text can be determined based on the executed or unexecuted machine instructions.

In S160, assembly is completed.

In this manner, the execution process of the machine instructions is monitored without the need for manual intervention, thereby freeing up human resources and improving the smoothness and efficiency of the assembly work.

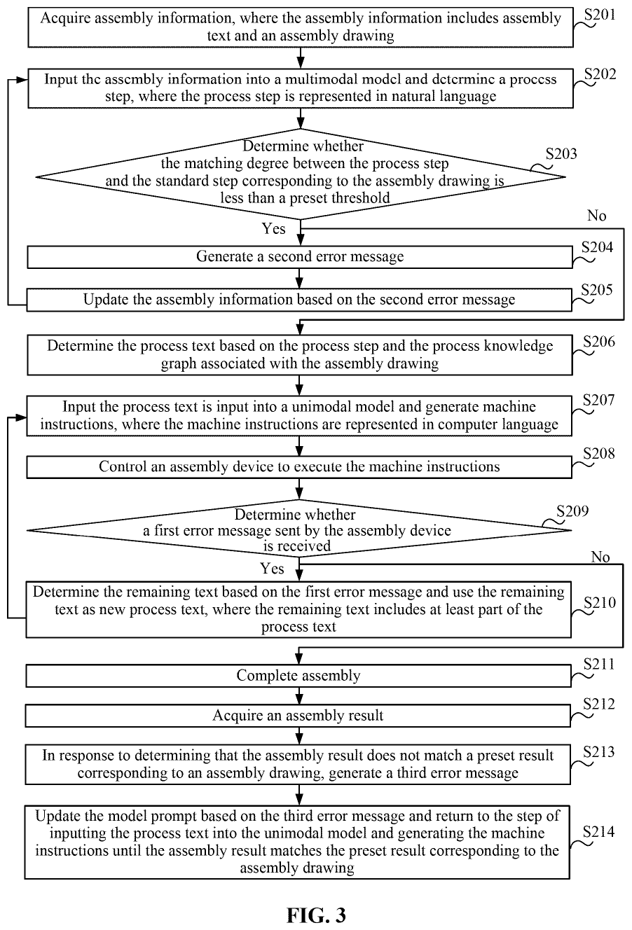

FIG. 3 is a flowchart of an assembly method according to an embodiment of the present disclosure. On the basis of the previous embodiment, this embodiment provides a method for verifying the process step and the assembly result. As shown in FIG. 3, the method includes the following steps:

In S201, assembly information is acquired, where the assembly information includes assembly text and an assembly drawing.

In an embodiment, the method of acquiring assembly information of step S201 may include the following seven steps:

In step b1, the voice information input by the user is collected and converted into text information based on a speech recognition algorithm.

The assembly device can integrate voice collection equipment (such as a microphone). When the voice information input by the user is collected, the assembly device can convert the voice information into text information based on a speech recognition algorithm. The speech recognition algorithm can be any machine learning or deep learning algorithm used for processing speech time-series signals.

By way of example, suppose a segment of voice information input by the user is collected. After being processed by the speech recognition algorithm, the resulting text information is “Please complete the assembly of the front and rear connecting flanges.”

By using the user's input voice information as the entry point for human-machine interaction and converting the voice information into text information based on speech recognition algorithm, the generation of machine instructions and their subsequent execution can always align with the user's expectation.

In step b2, the matching degree between the text information and each standard text is determined.

In an embodiment, the assembly device may be preconfigured with a standard text library and a drawing library. The standard text library stores multiple standard texts, and the drawing library stores multiple assembly drawings. Each standard text corresponds to an assembly drawing, meaning that a standard text and an assembly drawing together form a data pair.

After converting the voice information into text information using a speech recognition algorithm, the matching degree between the text information and each standard text is determined. The matching degree between the text information and a standard text indicates the similarity or association level between the two. If the matching degree between the text information and a standard text is greater than or equal to a preset matching threshold, it is indicated that the text information is similar to that standard text. Conversely, if the matching degree between the text information and the standard text is less than the preset threshold, it is indicated that there is a significant difference between the text information and the standard text.

The value of the preset matching degree may be set according to actual needs, such as 0.8, 0.9, or 0.95. This is not limited by this embodiment of the present disclosure.

In step b3, if the matching degree between the text information and at least one standard text is greater than or equal to the preset matching degree, the standard text with the highest matching degree is selected as the assembly text.

In step b4, the assembly drawing is selected from the drawing library based on the assembly text.

With reference to steps b3 and b4, when the matching degree between the text information and at least one standard text is greater than or equal to the preset matching degree, it is considered that the standard text with the highest matching degree is essentially the same as the text information. This standard text is then used as the assembly text, allowing for the quick selection of the corresponding assembly drawing from the drawing library.

By way of example, suppose the text information is “Please complete the assembly of the front and rear connecting flanges.” After comparing it with various standard texts, it is determined that the matching degree between the text information and the standard text “assembly of the front and rear connecting flanges” is greater than or equal to the preset matching degree. In this case, the standard text “assembly of the front and rear connecting flanges” is directly used as the assembly text, and the corresponding assembly drawing for “assembly of the front and rear connecting flanges” can be selected from the drawing library.

In step b5, if the matching degree between the text information and each standard text is less than the preset matching degree, the text information is used as the assembly text.

In step b6, the attribute information of the assembly device is acquired.

In step b7, the assembly diagram is selected from the diagram library based on the attribute information of the assembly device and the assembly text.

With reference to steps b5 to b7, when the matching degree between the text information and each standard text is less than the preset matching degree, it is considered that no standard text in the standard text library is essentially the same as the text information. In this case, the text information is used as the assembly text. Then, based on the attribute information of the assembly device, the corresponding assembly diagram is selected from the diagram library.

The attribute information of the assembly device includes, but is not limited to: the picture of the assembly device, the type of the assembly device, the number of the assembly devices, the name of the assembly device, and the information of the to-be-assembled workpieces placed on the assembly device.

By way of example, suppose the text information is “Please complete the assembly of the flange.” After comparing it with each standard text, it is determined that the match degree between the text information and each standard text is less than the preset matching degree. In this case, “Please complete the assembly of the flange” is taken as the assembly text, and the attribute information of the assembly device is obtained as “pictures of flanges for workpieces 1 and 2.” Therefore, based on the attribute information of the assembly device and the assembly text, the corresponding assembly drawing for “the assembly of the front and rear connecting flanges” is selected from the drawing library.

In S202, the assembly information is input into a multimodal model, and a process step is determined, where the assembly information includes assembly text and an assembly drawing, and the process step is represented in natural language.

To achieve fully automated parsing of assembly information, the present disclosure trains a multimodal model in advance. By inputting the assembly information into the multimodal model, the model parses and reasons to output the process step, thereby achieving the automatic conversion from the assembly drawing to the process step. The process step is represented in natural language.

To ensure the accuracy of the process step, the present disclosure also includes a verification process for the process step, ensuring the correctness of the subsequent generated process text and machine instructions. The step for verifying the process step includes steps S203 to S205.

In step S203, it is determined whether the matching degree between the process step and the standard step corresponding to the assembly drawing is less than a preset threshold; if yes, step S204 is performed; and if no, step S206 is performed.

The matching degree between the process step and the standard step corresponding to the assembly drawing indicates the similarity/degree of correlation between the process step and the standard step corresponding to the assembly drawing. If the matching degree between the process step and the standard step corresponding to the assembly drawing is greater than or equal to the preset threshold, it is indicated that the process step is similar to the standard step corresponding to the assembly drawing, and the process step is correct. In this case, step S206 can be directly executed. If the matching degree is less than the preset threshold, it is indicated that the process step differs significantly from the standard step corresponding to the assembly drawing, and the process step is incorrect. In this case, the assembly information needs to be updated, and the process step should be redetermined for further determination.

The value of the preset threshold may be set according to actual requirements, such as 0.8, 0.9, or 0.95. This is not limited by this embodiment of the present disclosure.

In S204, a second error message is generated.

In S205, the assembly information is updated based on the second error message, and S202 is performed.

The operation of updating the assembly information and returning to step S202 to redetermine the process step until the matching degree between the process step and the standard step corresponding to the assembly drawing is greater than or equal to the preset threshold ensures the accuracy of the process step.

Due to the specificity of the professional terminology in assembly work, the process step cannot be directly executed by the assembly device. Therefore, the process step, expressed in natural language, need to be converted into machine instructions in a computer-readable language. To address the limitation of existing technologies that rely solely on predefined expert knowledge for reasoning, the present disclosure uses a unimodal model. Since the process step cannot be directly input into the unimodal model, it must first be converted into process text (also understood as a text sequence) that can be recognized by the unimodal model. The conversion process is shown in step S206.

In the present disclosure, the difference between the multimodal model and the unimodal model lies in the following: The multimodal model is capable of recognizing information expressed in natural language (such as the assembly text and the process step) whereas the unimodal model cannot recognize information expressed in natural language.

In S206, the process text is determined based on the process step and the process knowledge graph associated with the assembly drawing.

In an embodiment, the process knowledge graph includes a basic graph and an encapsulated function.

S206 includes the following three steps:

In step c1, the process step is decomposed to obtain several process actions and an action topology, where the action topology is configured to indicate the position and the dependency relationship of each of the process actions in the process step.

The process knowledge graph is a knowledge graph built based on experiences in the field of Industrial-Internet-based intelligent manufacturing technologies. The process knowledge graph includes a basic graph and an encapsulated function. Typically, one assembly plan corresponds to one process knowledge graph; therefore, the process knowledge graph is associated with the assembly drawing of its corresponding assembly plan.

In step c2, action text corresponding to each of the process actions is determined based on the process knowledge graph.

Optionally, for any of the process actions, determining action text corresponding to the process action based on the process knowledge graph includes determining a workpiece feature and an assembly feature of the process action based on the basic graph; determining a control parameter of the process action based on the encapsulation function, with the process requirements as constraints; and determining the action text corresponding to the process action based on the workpiece feature, the assembly feature, and the control parameter.

Considering that the process actions should be related to the to-be-assembled workpieces and the corresponding assembly device, as well as the contextual environment, the instructions stored in the basic graph should not be fixed instructions. Instead, they should be instructions with some missing knowledge, such as control parameters. Therefore, for any process action, based on the basic graph, only the workpiece feature and assembly feature of the process action can be determined.

For example, the workpiece feature is obtained. Based on the workpiece feature, the corresponding feature entity is looked up in the basic graph. Then, using the feature entity or the workpiece name derived from the processed input, the corresponding workpiece entity is found. Next, based on the assembly feature, the assembly operation is identified. When inferring the instructions, the properties of the workpiece, the properties of the feature, and the properties of the assembly device (such as a gripper or a robotic arm) are applied. After determining the workpiece feature and assembly feature for the process action, the process requirements are used as constraints. Then, based on the encapsulation function, the control parameter for the process action is determined. Once the control parameter is determined, it is filled into the instructions constructed from the workpiece feature and assembly feature, thereby determining the action text corresponding to the process action.

Optionally, the encapsulation function may be a mechanism function.

In step c3, action texts corresponding to the process actions are combined according to the action topology to obtain the process text.

In this manner, the topological order of the process texts is ensured to be consistent with the process steps, thereby ensuring the accuracy of subsequent machine instruction generation.

In this manner, the process step is decomposed, and the action text corresponding to each process action is ensured to be locally optimal. Then, the action texts corresponding to the process actions are combined according to the action topology, ensuring that the topological order of the process texts is consistent with the process steps, thereby ensuring the smoothness of the entire assembly process. Moreover, the process text constructed in this manner follows a fixed pattern so that when the process text is used as input to the unimodal model, the following effects are achieved: constraining the model's reasoning ability, preventing the generation of incorrect instructions due to the model's inherent tendency to make erroneous inferences, and thus ensuring the accuracy of the subsequently generated machine instructions.

In S207, the process text is input into a unimodal model, and machine instructions are generated, where the machine instructions are represented in computer language.

The unimodal model can be a pretrained model capable of converting process text into machine instructions that can be executed by the assembly device.

In an embodiment, an input end of the unimodal model is provided with a primitive function library, the primitive function library includes several instruction functions, the instruction functions are represented in the computer language, and the computer language includes at least one of machine language, assembly language, high-level language, or specialized language.

Inputting the process text into the unimodal model and generating the machine instructions includes constructing a model prompt based on the process text and the primitive function library; and inputting the model prompt into the unimodal model and generating the machine instructions. In this manner, the model prompt is constructed using the primitive function library and the process text and used as the input to the unimodal model so that the input to the model can be further optimized to ensure the accuracy of the machine instructions.

### An Example Instruction Function:

move_obj (robot_name, obj, mode, (xd, yd, zd), (rl, rm, rn)): After the robot robot_name grabs the object obj, move or rotate the object.
move_robot (robot_name, mode, (xd, yd, zd), (rl, rm, rn)): Move or rotate the object by robot robot_name according to mode.
move_origin (robot_name, obj): After the robot robot_name grabs the object obj, return to the origin.
move_turn (robot_name): Flip the robot robot_name.
move_photo (robot_name): Move the robot robot_name to the photo-taking position.
move_home (robot_name): Make the robot robot_name return home.
release (robot_name): The robot robot_name releases.
grab (robot_name): The robot robot_name grabs.

### Example Machine Instructions:

move_obj (robot_name, obj, mode, (xd, yd, zd), (rl, rm, rn)): After the robot robot_name grabs the object obj, move or rotate the object. The parameters in this instruction are as follows:
robot_name: Name of the robot.
obj: The object.
mode: Movement mode of the robot:
(1) mode=1 represents joint movement.
(2) mode=2 represents linear movement.
(3) mode=3 represents force control to find a plane or other things.
xd: The distance the robot moves in the positive direction along the x-axis after grabbing the object obj.
yd: The distance the robot moves in the positive direction along the y-axis after grabbing the object obj.
zd: The distance the robot moves in the positive direction along the z-axis after grabbing the object obj.
rl: The angle the robot rotates around the x-axis in the positive direction after grabbing the object obj.
rm: The angle the robot rotates around the y-axis in the positive direction after grabbing the object obj.
rn: The angle the robot rotates around the z-axis in the positive direction after grabbing the object obj.

### Example Codes:

move_obj (UR_robot, obj, 2, (0, 0, 0), (0, 0, 0)): The UR robot moves the object obj with linear motion.
move_obj (UR_robot, obj, 1, (0, 0, +zd), (0, 0, 0)): The UR robot moves the object obj with joint movement in the positive direction along the z-axis by a displacement of zd.
move_obj (AUBO_robot, obj, 2, (0, 0, +zd), (0, 0, 0)): The AUBO robot moves the object obj with linear motion in the positive direction along the z-axis by a displacement of zd.
move_obj (UR_robot, obj, 2, (0, +yd, 0), (0, 0, 0)): The UR robot moves the object obj with linear motion in the positive direction along the y-axis by a displacement of yd.
move_obj (AUBO_robot, obj, 2, (−xd, 0, 0), (0, 0, 0)): The AUBO robot moves the object obj with linear motion in the negative direction along the x-axis by a displacement of xd.
move_obj (UR_robot, obj, 1, (0, 0, 0), (+rl, 0, 0)): The UR robot moves the object obj with joint movement in the positive direction along the x-axis by a displacement of rl.
move_obj (UR_robot, obj, 1, (0, 0, 0), (−rl, 0, 0)): The UR robot moves the object obj with joint movement in the negative direction along the x-axis by a displacement of rl.
move_obj (AUBO_robot, obj, 1, (0, 0, 0), (0, +rm, 0)): The AUBO robot moves the object obj with joint movement in the positive direction along the y-axis by a displacement of rm.
move_obj (AUBO_robot, obj, 1, (0, 0, 0), (0, −rm, 0)): The AUBO robot moves the object obj with joint movement in the negative direction along the y-axis by a displacement of rm.
move_obj (UR_robot, obj, 1, (0, 0, 0), (0, 0, +rn)): The UR robot moves the object obj with joint movement in the positive direction along the z-axis by a displacement of rn.
move_obj (AUBO_robot, obj, 1, (0, 0, 0), (0, 0, −rn)): The AUBO robot moves the object obj with joint movement in the negative direction along the z-axis by a displacement of rn.
move_robot (robot_name, mode, (xd, yd, zd), (rl, rm, rn)): Move or rotate the object by robot robot_name according to mode.
move_origin (robot_name, obj): After the robot robot_name grabs the object obj, return to the origin.
move_turn (robot_name): Flip the robot robot_name.
move_photo (robot_name): Move the robot robot_name to the photo-taking position.
move_assem (robot_name): Move the robot robot_name to the assembly position.
move_home (robot_name): Make the robot robot_name return home.
release (robot_name): The robot robot_name releases.
grab (robot_name): The robot robot_name grabs.
move_Visual_Rec (obj1, obj2): Call the visual recognition algorithm to obtain the positions of objects obj1 and obj2.

Units are mm.

Note: The left side is positive movement, the right side is negative movement, the front side is positive movement, and the rear side is negative movement.

The following provides three examples to illustrate the step of inputting the process text into the unimodal model and generating the machine instructions in the present disclosure.

Example one: Suppose the process text is as follows: Call the visual recognition algorithm to identify the positions of the front connecting flange and the rear connecting flange. The AUBO robot moves to the rear connecting flange with joint motion along the positive z-axis by +150. The AUBO robot moves to the rear connecting flange with linear motion along the negative z-axis by −20. The AUBO robot grabs. The AUBO robot moves to the rear connecting flange with linear motion along the positive z-axis by +150. The AUBO robot flips. The AUBO robot moves to the photo-taking position. The UR robot moves to the front connecting flange with joint motion along the positive z-axis by +150. The UR robot moves to the front connecting flange with linear motion along the negative z-axis by −20. The UR robot grabs. The UR robot moves to the front connecting flange with linear motion along the positive z-axis by +150. The UR robot flips. The UR robot moves to the photo-taking position.

The machine instructions generated after the process text is input into the unimodal model are as follows:
move_Visual_Rec (FrontConnectingFlange, RearConnectingFlange);
move_obj (AUBORobot, RearConnectingFlange, 1, (0, 0, +150), (0, 0, 0));
move_obj (AUBORobot, RearConnectingFlange, 2, (0, 0, −20), (0, 0, 0));
grab (AUBORobot);
move_obj (AUBORobot, RearConnectingFlange, 2, (0, 0, +150), (0, 0, 0));
move_turn (AUBORobot);
move_photo (AUBORobot);
move_obj (URRobot, FrontConnectingFlange, 1, (0, 0, +150), (0, 0, 0));
move_obj (URRobot, FrontConnectingFlange, 2, (0, 0, −20), (0, 0, 0));
grab (URRobot);
move_obj (URRobot, FrontConnectingFlange, 2, (0, 0, +150), (0, 0, 0));
move_turn (URRobot);
move_photo (URRobot).

Example two: Suppose the process text is as follows: Call the visual recognition algorithm to identify the positions of the front connecting flange and the rear connecting flange. Flip the UR robot. Move the AUBO robot to the assembly position. Perform shaft hole assembly between the rear connecting flange and the front connecting flange. The UR robot releases. Move the UR robot to the preassembly position. Send the UR robot home.

The machine instructions generated after the process text is input into the unimodal model are as follows:
move_Visual_Rec (FrontConnectingFlange, RearConnectingFlange);
move_turn (URRobot);
move_assem (AUBORobot);
shaft_hole_assem (RearConnectingFlange, FrontConnectingFlange);
release (URRobot);
move_assem_UR_yu ( )
move_home (URRobot).

Example three: Suppose the process text is as follows: Call the visual recognition algorithm to identify the positions of the hexagonal bolt head and the front and rear connecting flanges. The UR robot moves to the bolt with joint motion along the positive z-axis by +50. The UR robot moves to the bolt with linear motion along the negative z-axis by −10. The UR robot grabs. The UR robot moves to the hexagonal bolt head with joint motion along the positive z-axis by +50. Send the UR robot home. Move the UR robot 10 mm along the positive z-axis. Perform threaded assembly between the bolt and the front and rear connecting flanges. The UR robot releases. Move the UR robot to the preassembly position. Send the UR robot home. Adjust the gripper. Flip the AUBO robot. Move the object to the prestorage position. Move the AUBO robot to the storage position. The AUBO robot releases. Move the object to the prestorage position. Send the AUBO robot home.

The machine instructions generated after the process text is input into the unimodal model are as follows:
move_Visual_Rec (HexagonalBoltHead, FrontAndRearConnectingFlange);
move_obj (URRobot, HexagonalBoltHead, 1, (0, 0, +50), (0, 0, 0));
move_obj (URRobot, HexagonalBoltHead, 2, (0, 0, −10), (0, 0, 0));
grab (URRobot);
move_obj (URRobot, HexagonalBoltHead, 1, (0, 0, +50), (0, 0, 0));
move_home (URRobot);
move_robot (URRobot, 1, (0, 0, 10), (0, 0, 0));
threaded_assem (HexagonalBoltHead, FrontAndRearConnectingFlange);
release (URRobot);
move_assem_UR_yu ( )
move_home (URRobot);
jig_zheng ( )
move_turn (AUBORobot);
move_yu_store ( )
move_store (AUBORobot);
release (AUBORobot);
move_yu_store ( )
move_home (AUBORobot);

In S208, an assembly device is controlled to execute the machine instructions.

In S209, it is determined whether a first error message sent by the assembly device is received; if yes, step S210 is performed; and if no, step S211 is performed.

Since the assembly device may require some time to execute the machine instructions, the assembly device needs to continuously check in real time whether the first error message has been received during this period. If the first error message is received from the assembly device, it is indicated that an error occurred in the machine instructions, and step S210 is executed to regenerate the machine instructions. If no error message is received from the assembly device, it is indicated that the machine instructions were executed correctly, and step S211 is executed to complete the assembly.

In an embodiment, the assembly device may be equipped with an exception capturing module, and the first error message is based on the information obtained by the exception capturing module. The exception capturing module has a fixed pattern to ensure that the assembly device can regenerate the correct machine instructions even when an assembly anomaly occurs.

In S210, the remaining text is determined based on the first error message, the remaining text is used as new process text, and S207 is performed again, where the remaining text includes at least part of the process text.

In an embodiment, the first error message can be understood as an external stimulus to the model, which triggers the update of the machine instructions based on this external stimulus.

In a possible embodiment, determining the remaining text includes determining executed instructions, where the executed instructions are instructions that are among the machine instructions and that have been executed when the assembly device sends the first error message; determining executed text based on the executed instructions; and determining the remaining text based on the executed text and the process text.

In another possible embodiment, determining the remaining text includes determining unexecuted instructions, where the unexecuted instructions are instructions that are among the machine instructions and that have not been executed when the assembly device sends the first error message; and determining the remaining text based on the unexecuted instructions.

In S211, assembly is completed.

In this manner, the execution process of the machine instructions is monitored without the need for manual intervention, thereby freeing up human resources and improving the smoothness and efficiency of the assembly work.

Optionally, after step S211 is executed, the present disclosure may also verify the assembly result, with the verification method as shown in steps S212 to S214.

In S212, an assembly result is acquired.

In S213, in response to determining that the assembly result does not match a preset result corresponding to an assembly drawing, a third error message is generated.

In S214, the model prompt is updated based on the third error message, and the step of inputting the process text into the unimodal model and generating the machine instructions is performed again until the assembly result matches the preset result corresponding to the assembly drawing.

In this manner, the continuous updating and optimization of machine instructions can be ensured. Regardless of changes in the types of to-be-assembled workpieces or the assembly device, a complete trajectory planning scheme can be generated in real time for the assembly device. This enables the assembly system to fully leverage the understanding, planning, and execution capabilities of large models during motion control, transforming it into a fully intelligent entity with autonomous cognitive and action capabilities. This avoids the rigidification of production lines, enhances the real-time operational flexibility of the assembly device, and provides a feasible solution for fully automated flexible assembly.

This embodiment of the present disclosure provides an assembly method. The assembly method includes acquiring process text, inputting the process text into a unimodal model, and generating machine instructions, where the machine instructions are represented in computer language; controlling an assembly device to execute the machine instructions; in response to receiving a first error message sent by the assembly device, updating the unimodal model based on the first error message, determining the remaining text based on the first error message, using the remaining text as new process text, using the updated unimodal model as a new unimodal model, and returning to the step of inputting the process text into the unimodal model and generating the machine instructions, where the remaining text includes at least part of the process text; and in response to receiving no first error message sent by the assembly device, completing assembly. The solution of this embodiment of the present disclosure involves inputting the acquired process text into a unimodal model, and generating machine instructions; controlling an assembly device to execute the machine instructions; in response to receiving a first error message sent by the assembly device, determining the remaining text based on the first error message, using the remaining text as new process text, and returning to the step of inputting the process text into the unimodal model and generating the machine instructions; and in response to receiving no first error message sent by the assembly device, completing assembly. The introduction of a unimodal model in the process of converting process text into machine instructions represented in computer language solves the problem in the related art where reasoning is limited to established expert knowledge, thereby enhancing the flexibility of the assembly system. Moreover, the execution process of the machine instructions is monitored by the exception capturing module of the assembly device. When the first error message sent by the assembly device is received, the remaining text is determined and used as new process text to regenerate machine instructions, eliminating the need for manual intervention, freeing up human resources, and improving the smoothness and efficiency of the assembly process.

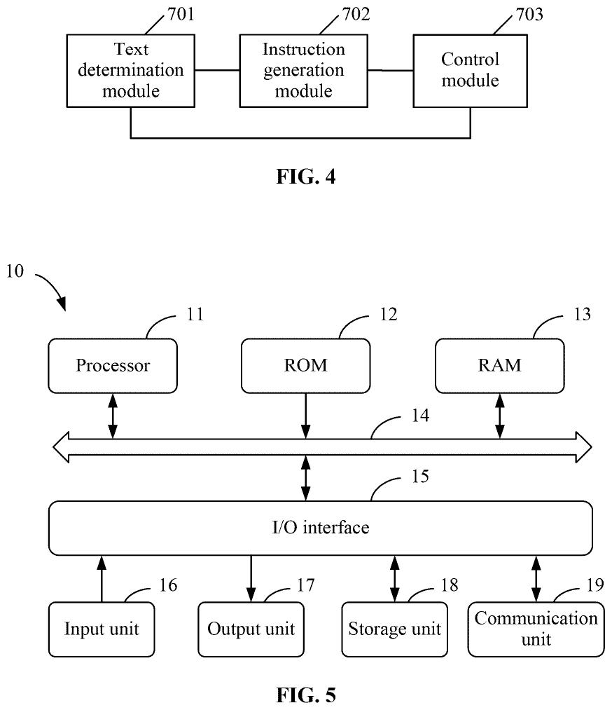

FIG. 4 is a diagram illustrating the structure of a display apparatus according to an embodiment of the present disclosure. As shown in FIG. 4, the apparatus includes a text determination module 701, an instruction generation module 702, and a control module 703.

The text determination module 701 is configured to acquire process text.

The instruction generation module 702 is configured to input the process text into a unimodal model and generate machine instructions, where the machine instructions are represented in computer language.

The control module 703 is configured to control an assembly device to execute the machine instructions and, in response to receiving no first error message sent by the assembly device, complete assembly.

The text determination module 701 is also configured to, in response to receiving a first error message sent by the assembly device, determine remaining text based on the first error message, where the first error message is acquired based on an exception capturing module of the assembly device, and the exception capturing module has a fixed pattern.

The instruction generation module 702 is also configured to use the remaining text as new process text and return to the step of inputting the process text into the unimodal model and generating the machine instructions, where the remaining text includes at least part of the process text.

Optionally, the text determination module 701 is configured to acquire assembly information, input the assembly information into a multimodal model, and determine a process step, where the assembly information includes assembly text and an assembly drawing, and the process step is represented in natural language; and determine the process text based on the process step and a process knowledge graph associated with the assembly drawing.

Optionally, the text determination module 701 is configured to determine executed instructions, where the executed instructions are instructions that are among the machine instructions and that have been executed when the assembly device sends the first error message; determine executed text based on the executed instructions; and determine the remaining text based on the executed text and the process text.

Optionally, the text determination module 701 is configured to determine the matching degree between the process step and a standard step corresponding to the assembly drawing; in response to determining that the matching degree between the process step and the standard step corresponding to the assembly drawing is less than a preset threshold, generate a second error message; and update the assembly information based on the second error message and return to the step of inputting the assembly information into the multimodal model and determining the process step until the matching degree between the process step and the standard step corresponding to the assembly drawing is greater than or equal to the preset threshold.

Optionally, the text determination module 701 is configured to decompose the process step to obtain several process actions and an action topology, where the action topology is configured to indicate the position and the dependency relationship of each of the process actions in the process step; determine action text corresponding to each of the process actions based on the process knowledge graph; and combine action text corresponding to the process actions according to the action topology to obtain the process text.

Optionally, the process step includes process requirements, and the process knowledge graph includes a basic graph and an encapsulation function; and the text determination module 701 is configured to determine a workpiece feature and an assembly feature of the process action based on the basic graph; determine a control parameter of the process action based on the encapsulation function, with the process requirements as constraints; and determine the action text corresponding to the process action based on the workpiece feature, the assembly feature, and the control parameter.

Optionally, an input end of the unimodal model is provided with a primitive function library, the primitive function library includes several instruction functions, the instruction functions are represented in the computer language, and the computer language includes at least one of machine language, assembly language, high-level language, or specialized language.

The instruction generation module 702 is configured to construct a model prompt based on the process text and the primitive function library; and input the model prompt into the unimodal model and generate the machine instructions.

Optionally, the instruction generation module 702 is also configured to acquire an assembly result; in response to determining that the assembly result does not match a preset result corresponding to an assembly drawing, generate a third error message; and update the model prompt based on the third error message and return to the step of inputting the process text into the unimodal model and generating the machine instructions until the assembly result matches the preset result corresponding to the assembly drawing.

The assembly apparatus of this embodiment of the present disclosure can execute the assembly method of any embodiment of the present disclosure and has function modules and beneficial effects corresponding to the executed method.

FIG. 5 is a diagram illustrating the structure of an electronic device according to an embodiment of the present disclosure. The electronic device 10 can be used to implement embodiments of the present disclosure. The electronic device is intended to represent various forms of digital computers, for example, a laptop computer, a desktop computer, a worktable, a personal digital assistant, a server, a blade server, a mainframe computer, and an applicable computer. The electronic device may also represent various forms of mobile apparatuses, for example, a personal digital assistant, a cellphone, a smartphone, a wearable device (such as a helmet, glasses, or a watch), and a similar computing apparatus. Herein the shown components, the connections and relationships between these components, and the functions of these components are illustrative only and are not intended to limit the implementation of the present disclosure as described and/or claimed herein.

As shown in FIG. 5, the electronic device 10 includes at least one processor 11 and a memory, such as a read-only memory (ROM) 12 or a random-access memory (RAM) 13, communicatively connected to the at least one processor 11. The memory stores a computer program executable by the at least one processor. The at least one processor 11 may perform various types of appropriate operations and processing according to a computer program stored in a read-only memory (ROM) 12 or a computer program loaded from a storage unit 18 to a random-access memory (RAM) 13. Various programs and data required for the operation of the electronic device 10 may also be stored in the RAM 13. The processor 11, the ROM 12, and the RAM 13 are connected to each other through a bus 14. An I/O interface 15 is also connected to the bus 14.

Multiple components in the electronic device 10 are connected to the I/O interface 15. The multiple components include an input unit 16 such as a keyboard or a mouse, an output unit 17 such as various types of display or speaker, the storage unit 18 such as a magnetic disk or an optical disk, and a communication unit 19 such as a network card, a modem, or a wireless communication transceiver. The communication unit 19 allows the electronic device 10 to exchange information/data with other devices over a computer network such as the Internet and/or various telecommunications networks.

The processor 11 may be various general-purpose and/or special-purpose processing components having processing and computing capabilities. Examples of the processor 11 include, but are not limited to, a central processing unit (CPU), a graphics processing unit (GPU), a special-purpose AI computing chip, a processor executing machine learning models and algorithms, a digital signal processor (DSP), and any appropriate processor, controller, and microcontroller. The processor 11 performs the various methods and processing described above, such as the assembly method.

In some examples, the assembly method may be implemented as computer programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are loaded to the RAM 13 and executed by the processor 11, one or more steps of the preceding assembly method may be performed. Alternatively, in other embodiments, the processor 11 may be configured, in any other suitable manner (for example, by means of firmware), to perform the assembly method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Computer programs for implementation of the methods of the present disclosure may be written in one programming language or any combination of multiple programming languages. The computer programs may be provided for a processor of a general-purpose computer, a special-purpose computer, or another programmable data processing apparatus to enable functions/operations specified in a flowchart and/or a block diagram to be implemented when the computer programs are executed by the processor. The computer programs may be executed entirely on a machine, partly on a machine, as a stand-alone software package, partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared, or semiconductor system, apparatus, or device or any appropriate combination thereof. Alternatively, the computer-readable storage medium may be a machine-readable signal medium. Examples of a machine-readable storage medium include an electrical connection based on one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on the electronic device. The electronic device has a display device (for example, a cathode-ray tube (CRT) or a liquid-crystal display (LCD) monitor) for displaying information to the user; and a keyboard and a pointing device (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

It is to be understood that various forms of the preceding flows may be used with steps reordered, added, or deleted. For example, the steps described in the present disclosure may be performed in parallel, in sequence, or in a different order as long as the desired result of the technical solutions provided in the present disclosure can be achieved. The execution sequence of these steps is not limited herein.

What is claimed is:

1. An assembly method, comprising:
acquiring process text, inputting the process text into a unimodal model, and generating machine instructions, wherein the machine instructions are represented in computer language;
controlling an assembly device to execute the machine instructions;
in response to receiving a first error message sent by the assembly device, determining remaining text based on the first error message, using the remaining text as new process text, and returning to a step of inputting the process text into the unimodal model and generating the machine instructions, wherein the first error message is acquired based on an exception capturing module of the assembly device, the exception capturing module has a fixed pattern, and the remaining text comprises at least part of the process text; and
in response to receiving no first error message sent by the assembly device, completing assembly.

2. The assembly method of claim 1, wherein acquiring the process text comprises:
acquiring assembly information, inputting the assembly information into a multimodal model, and determining a process step, wherein the assembly information comprises assembly text and an assembly drawing, and the process step is represented in natural language; and
determining the process text based on the process step and a process knowledge graph associated with the assembly drawing.

3. The assembly method of claim 2, wherein determining the remaining text comprises:
determining executed instructions, wherein the executed instructions are instructions that are among the machine instructions and that have been executed when the assembly device sends the first error message;
determining executed text based on the executed instructions; and
determining the remaining text based on the executed text and the process text.

4. The assembly method of claim 2, after determining the process step, the method further comprising:
determining a matching degree between the process step and a standard step corresponding to the assembly drawing;
in response to determining that the matching degree between the process step and the standard step corresponding to the assembly drawing is less than a preset threshold, generating a second error message; and
updating the assembly information based on the second error message, and returning to a step of inputting the assembly information into the multimodal model and determining the process step until the matching degree between the process step and the standard step corresponding to the assembly drawing is greater than or equal to the preset threshold.

5. The assembly method of claim 2, wherein determining the process text based on the process step and the process knowledge graph associated with the assembly drawing comprises:
decomposing the process step to obtain process actions and an action topology, wherein the action topology is configured to indicate a position and a dependency relationship of each of the process actions in the process step;
determining action text corresponding to each of the process actions based on the process knowledge graph; and
combining action text corresponding to the process actions according to the action topology to obtain the process text.

6. The assembly method of claim 5, wherein the process step comprises process requirements, and the process knowledge graph comprises a basic graph and an encapsulation function; and
for any of the process actions, determining action text corresponding to a process action based on the process knowledge graph comprises:
determining a workpiece feature and an assembly feature of the process action based on the basic graph;
determining a control parameter of the process action based on the encapsulation function, with the process requirements as constraints; and
determining the action text corresponding to the process action based on the workpiece feature, the assembly feature, and the control parameter.

7. The assembly method of claim 1, wherein an input end of the unimodal model is provided with a primitive function library, the primitive function library comprises an instruction function, the instruction function is represented in the computer language, and the computer language comprises at least one of machine language, assembly language, high-level language, or specialized language; and
inputting the process text into the unimodal model and generating the machine instructions comprises:
constructing a model prompt based on the process text and the primitive function library; and
inputting the model prompt into the unimodal model and generating the machine instructions.

8. The assembly method of claim 7, after completing the assembly, the assembly method further comprising:
acquiring an assembly result;
in response to determining that the assembly result does not match a preset result corresponding to an assembly drawing, generating a third error message; and
updating the model prompt based on the third error message and returning to a step of inputting the process text into the unimodal model and generating the machine instructions until the assembly result matches the preset result corresponding to the assembly drawing.

9. An electronic device, comprising a processor and a memory communicatively connected to the processor,
wherein the memory stores a computer program executable by the processor to enable the processor to perform an assembly method;
wherein the assembly method comprises:
acquiring process text, inputting the process text into a unimodal model, and generating machine instructions, wherein the machine instructions are represented in computer language;
controlling an assembly device to execute the machine instructions;
in response to receiving a first error message sent by the assembly device, determining remaining text based on the first error message, using the remaining text as new process text, and returning to a step of inputting the process text into the unimodal model and generating the machine instructions, wherein the first error message is acquired based on an exception capturing module of the assembly device, the exception capturing module has a fixed pattern, and the remaining text comprises at least part of the process text; and
in response to receiving no first error message sent by the assembly device, completing assembly.

11. The electronic device of claim 9, wherein acquiring the process text comprises:
acquiring assembly information, inputting the assembly information into a multimodal model, and determining a process step, wherein the assembly information comprises assembly text and an assembly drawing, and the process step is represented in natural language; and
determining the process text based on the process step and a process knowledge graph associated with the assembly drawing.

12. The electronic device of claim 11, wherein determining the remaining text comprises:
determining executed instructions, wherein the executed instructions are instructions that are among the machine instructions and that have been executed when the assembly device sends the first error message;
determining executed text based on the executed instructions; and
determining the remaining text based on the executed text and the process text.

13. The electronic device of claim 11, after determining the process step, the method further comprising:
determining a matching degree between the process step and a standard step corresponding to the assembly drawing;
in response to determining that the matching degree between the process step and the standard step corresponding to the assembly drawing is less than a preset threshold, generating a second error message; and
updating the assembly information based on the second error message, and returning to a step of inputting the assembly information into the multimodal model and determining the process step until the matching degree between the process step and the standard step corresponding to the assembly drawing is greater than or equal to the preset threshold.

14. The electronic device of claim 11, wherein determining the process text based on the process step and the process knowledge graph associated with the assembly drawing comprises:
decomposing the process step to obtain process actions and an action topology, wherein the action topology is configured to indicate a position and a dependency relationship of each of the process actions in the process step;
determining action text corresponding to each of the process actions based on the process knowledge graph; and
combining action text corresponding to the process actions according to the action topology to obtain the process text.

15. The electronic device of claim 14, wherein the process step comprises process requirements, and the process knowledge graph comprises a basic graph and an encapsulation function; and
for any of the process actions, determining action text corresponding to a process action based on the process knowledge graph comprises:
determining a workpiece feature and an assembly feature of the process action based on the basic graph;
determining a control parameter of the process action based on the encapsulation function, with the process requirements as constraints; and
determining the action text corresponding to the process action based on the workpiece feature, the assembly feature, and the control parameter.

16. The electronic device of claim 9, wherein an input end of the unimodal model is provided with a primitive function library, the primitive function library comprises an instruction function, the instruction function is represented in the computer language, and the computer language comprises at least one of machine language, assembly language, high-level language, or specialized language; and
inputting the process text into the unimodal model and generating the machine instructions comprises:
constructing a model prompt based on the process text and the primitive function library; and
inputting the model prompt into the unimodal model and generating the machine instructions.

17. The electronic device of claim 16, after completing the assembly, the assembly method further comprising:
acquiring an assembly result;
in response to determining that the assembly result does not match a preset result corresponding to an assembly drawing, generating a third error message; and
updating the model prompt based on the third error message and returning to a step of inputting the process text into the unimodal model and generating the machine instructions until the assembly result matches the preset result corresponding to the assembly drawing.

18. A non-transitory computer-readable storage medium, storing computer instructions, wherein the computer instructions are configured to enable a processor to perform an assembly method when the computer instructions are executed by the processor;
wherein the assembly method comprises:
acquiring process text, inputting the process text into a unimodal model, and generating machine instructions, wherein the machine instructions are represented in computer language;
controlling an assembly device to execute the machine instructions;
in response to receiving a first error message sent by the assembly device, determining remaining text based on the first error message, using the remaining text as new process text, and returning to a step of inputting the process text into the unimodal model and generating the machine instructions, wherein the first error message is acquired based on an exception capturing module of the assembly device, the exception capturing module has a fixed pattern, and the remaining text comprises at least part of the process text; and
in response to receiving no first error message sent by the assembly device, completing assembly.

19. The non-transitory computer-readable storage medium of claim 18, wherein acquiring the process text comprises:
acquiring assembly information, inputting the assembly information into a multimodal model, and determining a process step, wherein the assembly information comprises assembly text and an assembly drawing, and the process step is represented in natural language; and
determining the process text based on the process step and a process knowledge graph associated with the assembly drawing.

20. The non-transitory computer-readable storage medium of claim 19, wherein determining the remaining text comprises:
determining executed instructions, wherein the executed instructions are instructions that are among the machine instructions and that have been executed when the assembly device sends the first error message;
determining executed text based on the executed instructions; and
determining the remaining text based on the executed text and the process text.
